(19) United States
(12) Patent Application Publication
(10) Pub. No.: US 2011/0023680 A1
(43) Pub. Date: Feb. 3, 2011

(54) PCB CUTTER MODULE WITH DETACHABLE CUTTERS

(76) Inventor: Kuo-Chung WANG, Yunlin County (TW)

Correspondence Address: Muncy, Geissler, Olds & Lowe, PLLC, 4000 Legato Road, Suite 310, FAIRFAX, VA, 22033, US

(21) Appl. No.: 12/512,607

(22) Filed: Jul. 30, 2009

(51) Int. Cl. B26D 7/26

(52) U.S. Cl. 83/698.21

(57) ABSTRACT

A PCB cutter module is disclosed to include a base having a magnetically attractive worktable, a plurality of cutters detachably attached to the worktable and secured thereto by magnetic attraction at selected locations in selected directions subject to the design of the PC board to be cut. By means of magnetic attraction, the cutters are adjustably replaceably secured to the magnetically attractive worktable to fit different cutting requirements for cutting different designs of PC boards or different sizes of PC boards.

### BACKGROUND OF THE INVENTION

1. Field of the Invention

The present invention relates to PCB cutter modules for cutting PC boards or the like, and more particularly, to such a PCB cutter module, which allows quick adjustment of the positions of cutters to fit different cutting requirements for cutting different designs or different sizes of PC boards.

2. Description of the Related Art

To eliminate the drawbacks of long operation time, complicated processing procedures and low yield rate of conventional manual fabrication methods, many different automatic and semi-automatic machine tools are created. The use of automatic or semi-automatic machine tools greatly reduces the processing time and labor and greatly improves the processing efficiency and quality. Further, the use of automatic or semi-automatic machine tools facilitates mass production of products. Further, different tools may be used for processing substrates for PC boards subject to desired sizes, shapes or specifications. For example, different cutter modules may be used for cutting substrates subject to different cutting requirements for different models. Conventional PCB cutter modules are not satisfactory in function because of the following drawbacks:
1. A conventional PCB cutter module generally comprises a mold plate and a plurality of cutters affixed to the mold plate. When the cutting edge of one cutter is damaged or unsharpened and a replacement is necessary during fabrication, the manufacturing line must be stopped, allowing removal of the PCB cutter module for a replacement. It is not economic to replace the whole assembly of the PCB cutter module when only one cutter or few cutters are damaged.
2. To fit different cutting requirements for cutting different designs or different sizes of board members for making PC boards having different specifications, different PCB cutter modules shall be used. However, it is not economic to use different PCB cutter modules for cutting different board members for making PC boards of different sizes and specifications.
3. When a PCB cutter module is not used, the cutters are kept affixed to the mold plate. During delivering or storing of the PCB cutter module, the person handling the PCB cutter module may be injured by the cutters accidentally, or external objects may be scratched or cut by the cutters accidentally.

Accordingly, there is a need for PCB cutter module that eliminates the aforesaid problems and allows quick replacement of the cutters individually.

### SUMMARY OF THE INVENTION

The present invention has been accomplished under the circumstances in view. It is one object of the present invention to provide a PCB cutter module, which allows free arrangement of the cutters to fit different cutting requirements for cutting different designs or different sizes of PC boards. It is another object of the preset invention to provide a PCB cutter module, which allows quick replacement of any damaged cutter individually during PCB fabrication. It is still another object of the present invention to provide a PCB cutter module, which storage of the cutters separately, avoiding accidental injury. It is still another object of the present invention to provide a PCB cutter module, which facilitates PC board fabrication and effectively reduces PC board manufacturing costs.

To achieve these and other objects of the present invention, a PCB cutter module comprises a base having a magnetically attractive worktable at the top, and a plurality of cutters detachably mounted on the magnetically attractive worktable for cutting a workpiece. Each cutter comprises a holder block secured to the magnetically attractive worktable at a selected location in a selected direction by magnetic attraction, and a cutter element fastened to the holder block for cutting the workpiece.

Further, the base has a rectangular profile, a plurality of positioning means located on the border thereof for positioning in a platform of a processing machine.

Further, the worktable has a plurality of locating grooves for the positioning of the holder blocks of the cutters and the supplementary holder blocks respectively and a magnet embedded in each of the locating grooves for securing the associating holder blocks by magnetic attraction. The PCB cutter module further comprises a plurality of position limit means respectively provided between the locating grooves and the holder blocks of the cutters and the supplementary holder blocks to prohibit displacement of the holder blocks of the cutters and the supplementary holder blocks relative to the locating grooves. Each position limit means comprises a male engagement member, for example, protrusion protruded from one side of the peripheral wall of one locating groove, and a female engagement member, for example, locating notch located on one side of the associating holder block or supplementary holder block.

### BRIEF DESCRIPTION OF THE DRAWINGS

FIG. 1 is an elevational view of a PCB cutter module in accordance with a first embodiment of the present invention.

FIG. 2 is an exploded view of the PCB cutter module in accordance with the first embodiment of the present invention.

FIG. 3 is a schematic drawing of the first embodiment of the present invention, showing installation of the PCB cutter module in a processing machine.

FIG. 4 is a schematic applied view of the present invention, showing a PC board set between two PCB cutter modules before attachment of the top-sided PCB cutter module to the bottom-sided PCB cutter module.

FIG. 5 corresponds to FIG. 4, showing the top-sided PCB cutter module to the bottom-sided PCB cutter module.

FIG. 6 is an exploded view of a PCB cutter module in accordance with a second embodiment of the present invention.

FIG. 7 is an enlarged view of a part of FIG. 6.

FIG. 8 is an exploded view of a PCB cutter module in accordance with a third embodiment of the present invention.

### DETAILED DESCRIPTION OF THE PREFERRED EMBODIMENT

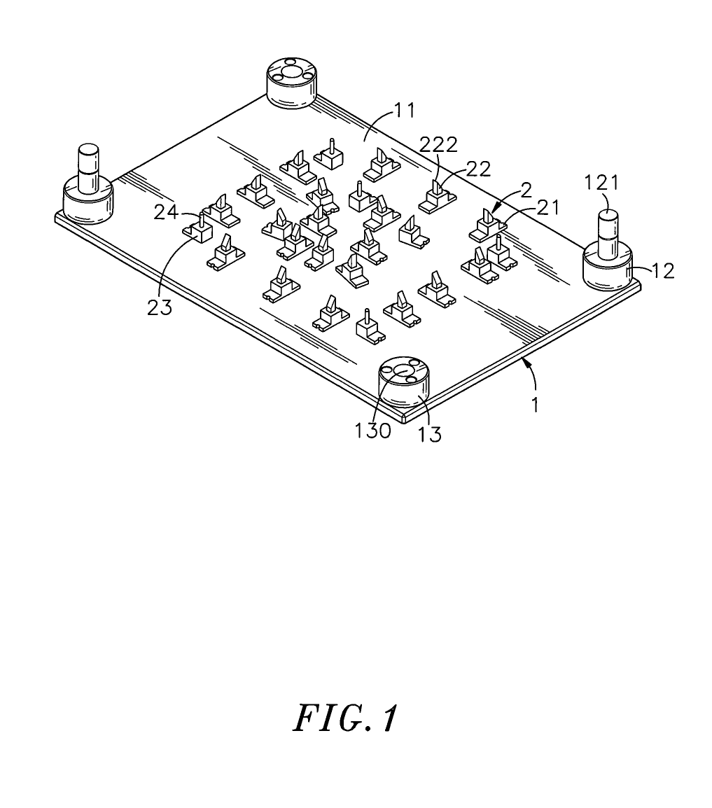

Referring to FIGS. 1˜3, a PCB cutter module in accordance with a first embodiment of the present invention is shown comprising a base 1 and a plurality of cutters 2.

The base 1 has a magnetically attractive worktable 11 provided at the top side thereof. The worktable 11 has a plurality of positioning portions 12 and alignment portions 13 alternatively arranged around the border. Each positioning portion 12 defines therein a positioning hole 120 for the mounting of a respective positioning rod 121. Each alignment portion 13 defines therein an alignment hole 130.

Each cutter 2 comprises a [symbol] -shaped or L-shaped holder block 21 that has a locating hole 210 formed in the top thereof, and a cutter element 22 that has a base portion 221 fastened to the locating hole 210 of the holder block 21 and a cutting edge 222 disposed at the top side. After installation of the respective cutter elements 22 in the respective holder blocks 21, the cutting edges 222 of the cutter elements 22 extend in different directions as designed. Further, [symbol] -shaped or L-shaped supplementary holder blocks 23 are selectively arranged relative to the holder blocks 21 of the cutters 2 to hold a respective alignment rod 24. Each [symbol] -shaped or L-shaped supplementary holder block 23 has a locating hole 230 located on the topmost edge thereof for the mounting of the associating alignment rod 24. Further, the [symbol] -shaped or L-shaped holder blocks 21 of the cutters 2 and the [symbol] -shaped or L-shaped supplementary holder blocks 23 are made of ferrous metals so that they can be secured to the magnetically attractive worktable 11 by magnetic attraction.

During installation of the PCB cutter module, the [symbol] -shaped or L-shaped holder blocks 21 of the cutters 2 and the [symbol] -shaped or L-shaped supplementary holder blocks 23 are attached to the magnetically attractive worktable 11 of the base panel 1 and respectively arranged at predetermined locations in predetermined directions. By means of magnetic attraction, the [symbol] -shaped or L-shaped holder blocks 21 and the [symbol] -shaped or L-shaped supplementary holder blocks 23 are secured to the magnetically attractive worktable 11 firmly in position. Thereafter, the base 1 is fastened to the platform 31 of a processing machine 3. By means of the positioning portions 12 and the alignment portions 13, the base 1 of the PCB cutter module can be quickly and accurately installed in the platform 31 of the processing machine 3.

During actual practice, two PCB cutter modules are reversely arranged on the platform 31 of the processing machine 3 with the PC board 4 set therebetween for cutting. At this time, positioning rods 121 are inserted with respective opposite ends into the alignment holes 130 of the alignment portions 13 of the bases 1 of the two PCB cutter modules, keeping the two PCB cutter modules in accurate alignment. At this time, the holes 410 in the waste material area 41 of the PC board 4 are respectively coupled to the alignment rods 24 at the [symbol] -shaped or L-shaped supplementary holder blocks 23, for enabling the connection portions 411 that are connected between the center part 42 and the border waste material area 41 to be cut off by the respective cutters 22, and therefore the center part 42, i.e., the finished product is separated from the border waste material area 41.

As stated above, the [symbol] -shaped or L-shaped holder blocks 21 of the cutters 2 and the [symbol] -shaped or L-shaped supplementary holder blocks 23 are secured to the magnetically attractive worktable 11 of the base panel 1 by means of magnetic attraction and respectively arranged at predetermined locations in predetermined directions subject to the design of the PC board 4 to be cut. Thus, the cutters 2 and the [symbol] -shaped or L-shaped supplementary holder blocks 23 can be adjustably arranged on the magnetically attractive worktable 11 of the base panel 1 to fit different PC board cutting requirements for cutting different designs of PC boards. Further, when the cutter element 22 of one cutter 2 starts to wear or is damaged, the respective cutter 2 can be directly detached from the magnetically attractive worktable 11 of the base panel 1 for a replacement. Thus, the invention facilitates maintenance and fits different cutting requirements for cutting different designs or different sizes of PC boards, i.e., the invention satisfies small-amount, large-variety production requirements.

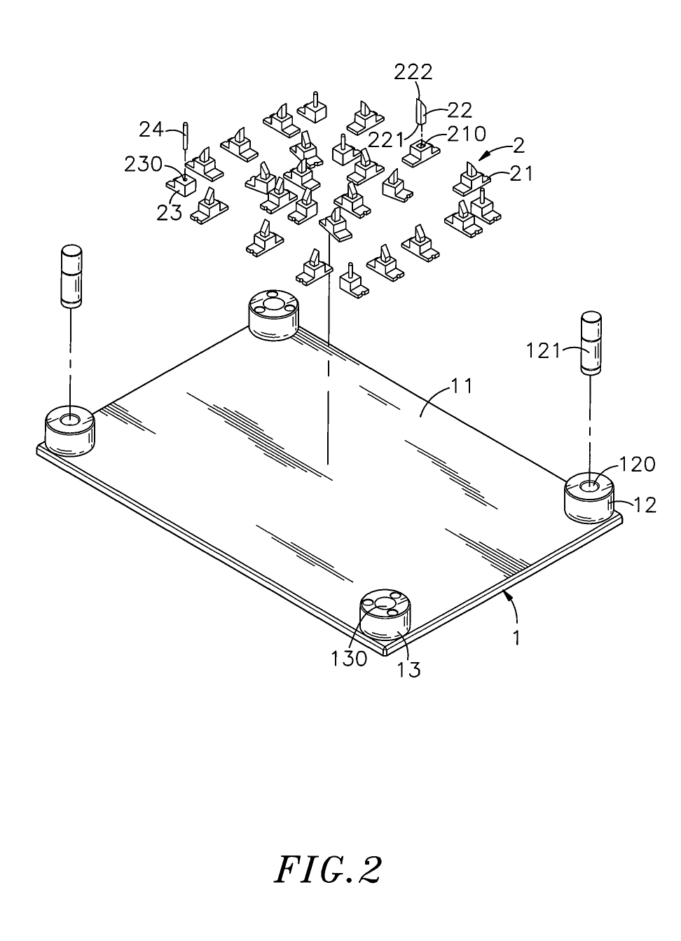

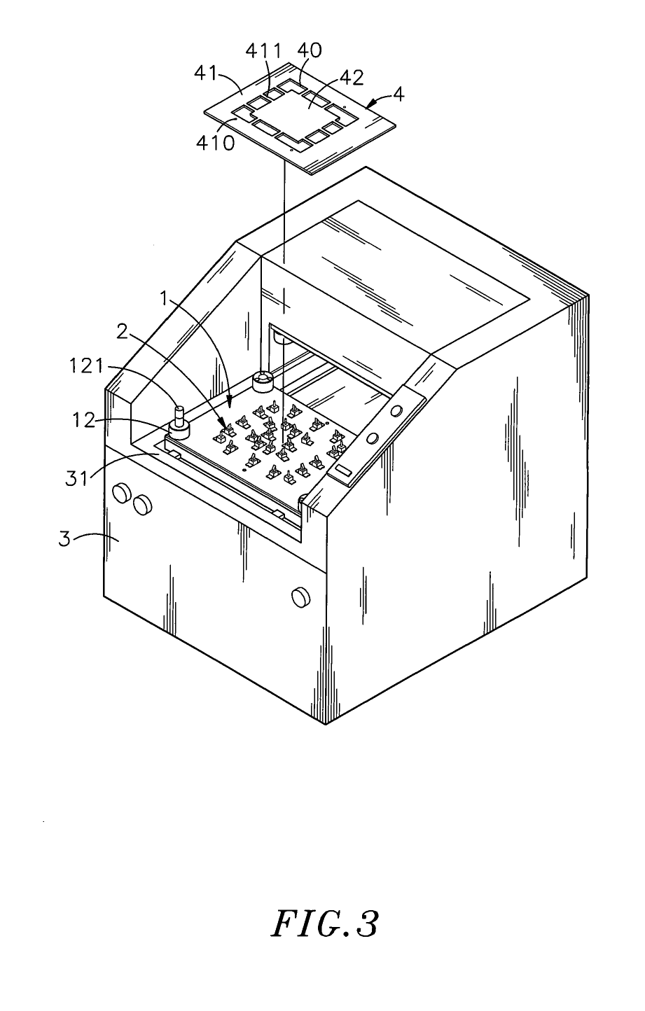

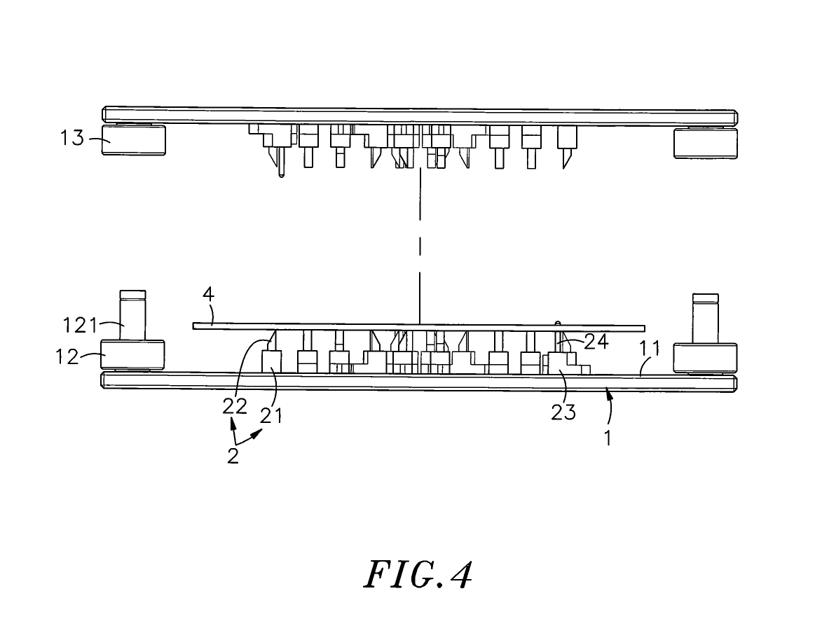

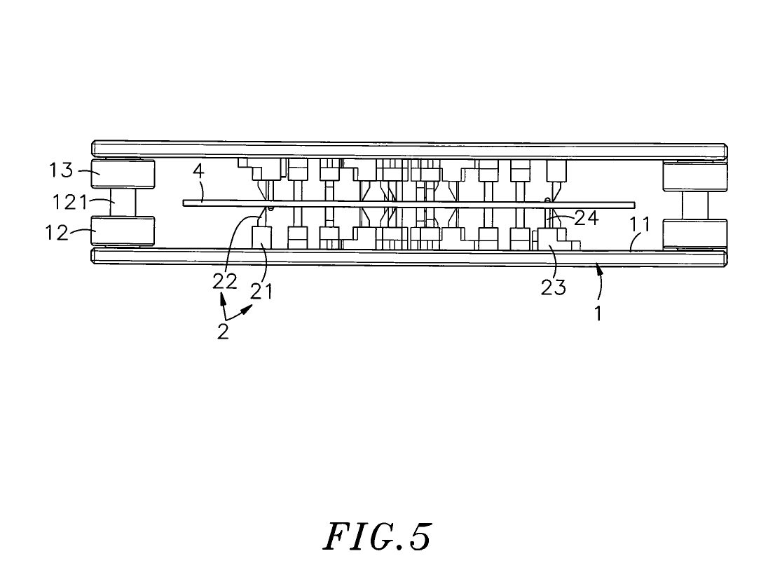

Referring to FIGS. 4 and 5 and FIGS. 2 and 3 again, the positioning holes 120 of the positioning portions 12 and the alignment holes 130 of the alignment portions 13 can be pin holes, and the positioning rods 121 can be pins fitting the positioning holes 120 and the alignment holes 130. Alternatively, the positioning holes 120 of the positioning portions 12 and the alignment holes 130 of the alignment portions 13 can be screw holes, and the positioning rods 121 can be screw rods for threading into the positioning holes 120 or the alignment holes 130.

Further, the magnetically attractive worktable 11 can be a permanent magnet or an electromagnetic member capable of securing the ferrous metal of the [symbol] -shaped or L-shaped holder blocks 21 of the cutters 2 and the [symbol] -shaped or L-shaped supplementary holder blocks 23.

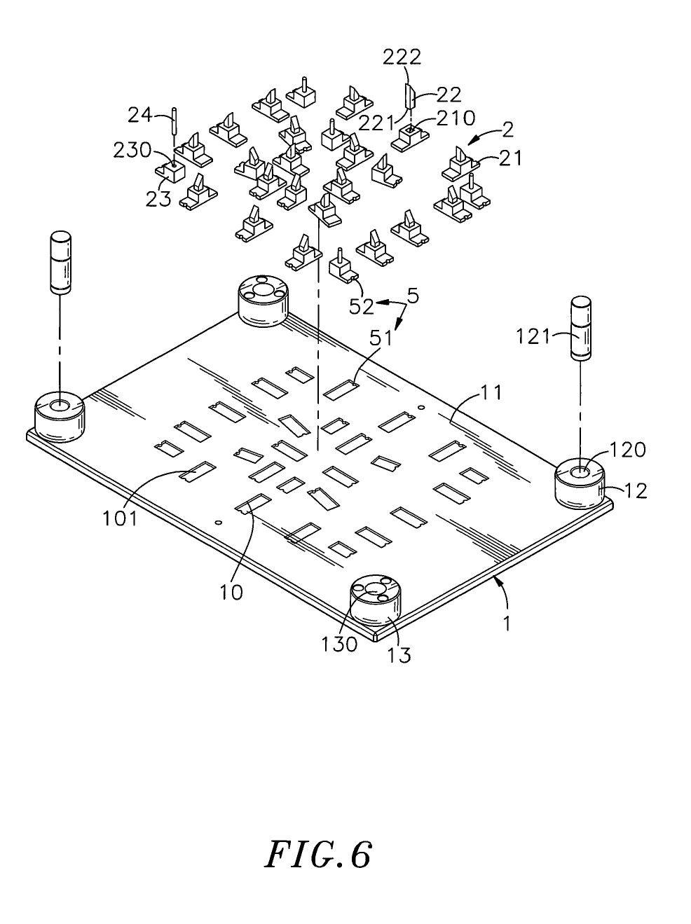

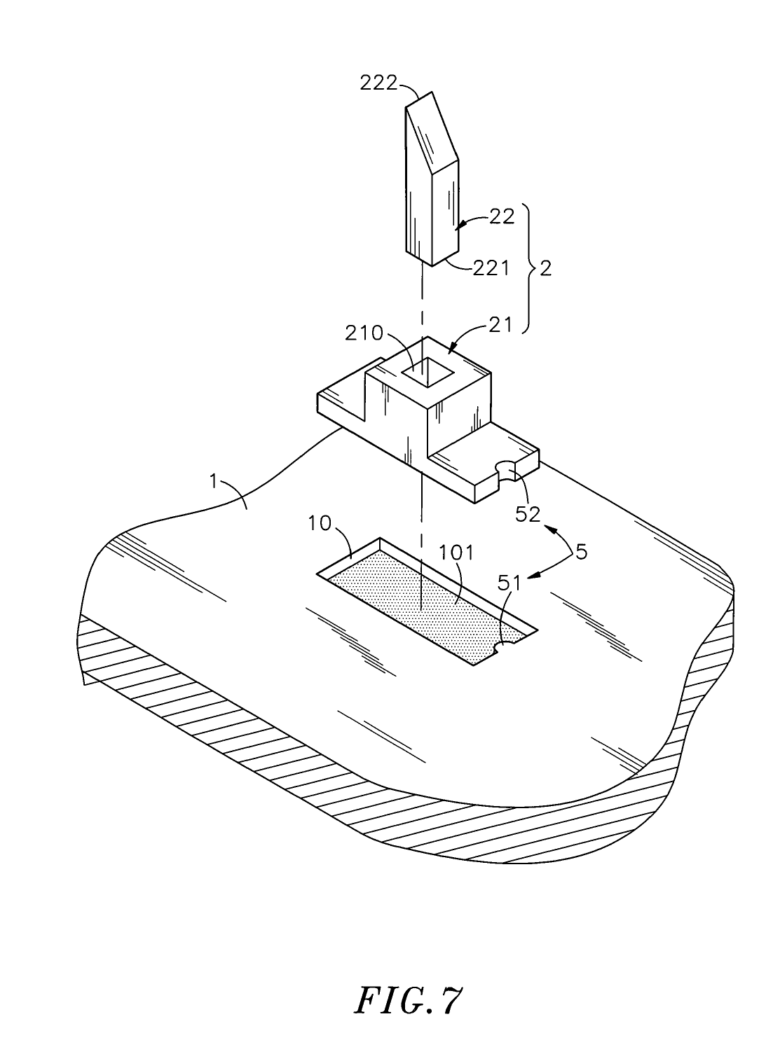

FIGS. 6 and 7 show a PCB cutter module in accordance with a second embodiment of the present invention. This second embodiment is substantially similar to the aforesaid first embodiment with the exception that the worktable 11 according to this second embodiment has a plurality of locating grooves 10 arranged at predetermined locations and extending in predetermined directions for the positioning of the [symbol] -shaped or L-shaped holder blocks 21 of the cutters 2 and the [symbol] -shaped or L-shaped supplementary holder blocks 23 respectively. The worktable 11 can be made of any of a variety of non-magnetic materials, and magnets 101 can be respectively embedded in the locating grooves 10 for securing the [symbol] -shaped or L-shaped holder blocks 21 of the cutters 2 and the [symbol] -shaped or L-shaped supplementary holder blocks 23 by magnetic attraction. Alternatively, screw joint, mortise and tenon joint, or any other similar fastening design can be provided between each locating groove 10 and the associating [symbol] -shaped or L-shaped holder block 21 or the [symbol] -shaped or L-shaped supplementary holder block 23, achieving detachable mounting of the [symbol] -shaped or L-shaped holder block 21 or the [symbol] -shaped or L-shaped supplementary holder block 23 in the associating locating groove 10.

Further, position limit means 5 may be provided between each locating groove 10 and the associating [symbol] -shaped or L-shaped holder block 21 or the [symbol] -shaped or L-shaped supplementary holder block 23 to prohibit displacement of the [symbol] -shaped or L-shaped holder block 21 or the [symbol] -shaped or L-shaped supplementary holder block 23 relative to the associating locating groove 10. The position limit means 5 comprises a male engagement member, for example, a protrusion 51 protruded from one side of the peripheral wall of the locating groove 10, and a female engagement member, for example, a locating notch 52 located on one side of the [symbol] -shaped or L-shaped holder blocks 21 or the [symbol] -shaped or L-shaped supplementary holder block 23 for engagement with the protrusion 51. Alternatively, the male engagement member (protrusion) 51 and the female engagement member (locating notch) 52 can be respectively formed in the [symbol] -shaped or L-shaped holder block 21 or the [symbol] -shaped or L-shaped supplementary holder block 23 and the peripheral wall of the locating groove 10, achieving the same effect. Further, a toothed joint may be used to substitute for the arrangement of the protrusion 51 and the locating notch 52, achieving the same effect.

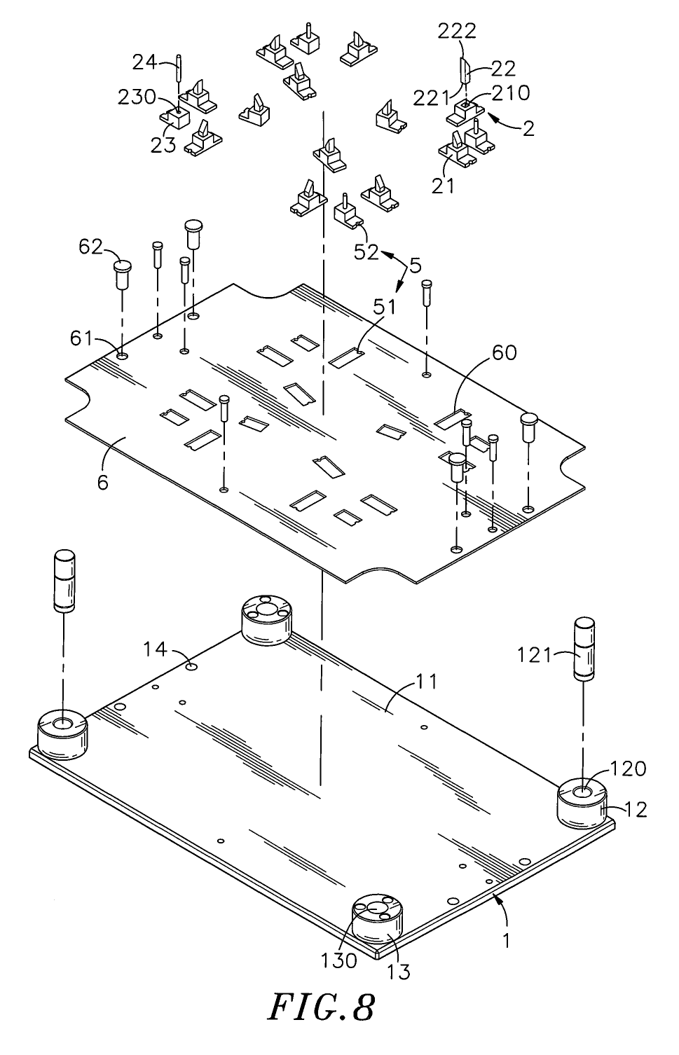

FIG. 8 is an exploded view of a PCB cutter module in accordance with a third embodiment of the present invention. According to this third embodiment, the worktable 11 of the base 1 is a plain table having a plurality of mounting holes 14 arranged along the border, and a mold plate 6 is detachably affixed to the top surface of the worktable 11 for securing the [symbol] -shaped or L-shaped holder blocks 21 of the cutters 2 and the [symbol] -shaped or L-shaped supplementary holder blocks 23. The mold plate 6 has a plurality of mounting through holes 61 respectively fastened to the mounting holes 14 of the worktable 11 by respective fastening elements, for example, screws 62, and a plurality of locating slots 60 arranged at predetermined locations and extending in predetermined directions for the positioning of the [symbol] -shaped or L-shaped holder blocks 21 of the cutters 2 and the [symbol] -shaped or L-shaped supplementary holder blocks 23 respectively, and position limit means 5 provided between each locating slot 60 and the associating [symbol] -shaped or L-shaped holder block 21 or the [symbol] -shaped or L-shaped supplementary holder block 23 to prohibit displacement of the [symbol] -shaped or L-shaped holder block 21 or the [symbol] -shaped or L-shaped supplementary holder block 23 relative to the associating locating slot 60. The position limit means 5 comprises a protrusion 51 protruded from one side of the peripheral wall of the locating slot 60, and a locating notch 52 located on one side of the [symbol] -shaped or L-shaped holder blocks 21 or the [symbol] -shaped or L-shaped supplementary holder block 23 for engagement with the protrusion 51. When going to cut a different design of PC board, the mold plate 6 is detached from the worktable 11 for the replacement of another design of mold plate that fits the design of the PC board to be cut.

As stated above, the invention provides a PCB cutter module for cutting PC boards. The PCB cutter module comprises a base 1 having a worktable 11, and a plurality of cutters 2 and supplementary holder blocks 23 that hold a respective alignment rod 24 detachably arranged on the worktable 11. The holder blocks 21 of the cutters 2 and the supplementary holder blocks 23 are detachably secured to the worktable 11 by magnetic attraction so that the positions of the holder blocks 21 of the cutters 2 and the supplementary holder blocks 23 are conveniently adjustable to fit different cutting requirements for cutting different designs of PC boards 4.

In conclusion, the invention provides a PCB cutter module, which has the following advantages and features:

1. The PCB cutter module comprises a base 1, and a plurality of cutters 2. The base 1 has the characteristics of ease of fabrication and low manufacturing cost. The cutters 2 can be conveniently and detachably arranged on the worktable 11 of the base 1 subject to predetermined locations and directions to fit different cutting requirements for cutting different designs of PC boards 4.

2. By means of magnetic attraction to secure the cutters 2 to the worktable 11 of the base 1, the installation of the cutters 2 is easy. Further, when the cutting edge 222 of the cutter element 22 of one cutter 2 starts to wear or is damaged, the cutter 2 in question can be conveniently removed from the worktable 11 of the base 1 for a replacement without throwing away the whole PCB cutter module, thereby saving much the cost.

3. When the PCB cutter module is not used, the cutters 2 can be removed from the worktable 11 of the base 1, and the cutters 2 and the base 1 can be separately packed for storage or delivery, avoiding accidental cutting injury or cutting edge damage and prolonging the work life of the cutters 2.

Therefore, the scope of the present invention is the detachable mounting arrangement between the worktable of the base and the cutters. By means of the arrangement of the position limit means to prohibit displacement of the cutters relative to the worktable of the base, any damaged cutter can be replaced with a new one conveniently and directly, saving much cutter replacement time and labor.

The present disclosure thus described with reference to the preferred embodiment, it will be obvious that various modifications, changes and enhancements may be made therein without departing from the spirit and scope of the present disclosure as defined in the disclosure and the claims.

What the invention claimed is:

1. A PCB cutter module, comprising:
a base, said base having a magnetically attractive worktable provided at a top side thereof; and
a plurality of cutters detachably mounted on said magnetically attractive worktable for cutting a workpiece, each said cutter comprising a holder block secured to said magnetically attractive worktable by magnetic attraction and a cutter element fastened to said holder block for cutting a workpiece.

2. The PCB cutter module as claimed in claim 1, further comprising a plurality of supplementary holder blocks secured to said magnetically attractive worktable by magnetic attraction, each said supplementary holder block having a locating hole located on the topmost edge thereof, and an alignment rod mounted in the locating hole of each of said supplementary holder blocks.

3. The PCB cutter module as claimed in claim 2, wherein said worktable has a plurality of locating grooves for the positioning of the holder blocks of said cutters and said supplementary holder blocks respectively and a magnet embedded in each of said locating grooves for securing the associating holder blocks by magnetic attraction; the PCB cutter module further comprises a plurality of position limit means respectively provided between said locating grooves and said holder blocks of said cutters and said supplementary holder blocks to prohibit displacement of said holder blocks of said cutters and said supplementary holder blocks relative to said locating grooves, each said position limit means comprising a male engagement member protruded from one side of the peripheral wall of one said locating groove, and a female engagement member located on one side of the associating holder block or supplementary holder block for engagement with said male engagement member.

4. The PCB cutter module as claimed in claim 2, wherein said worktable has a plurality of locating grooves for the positioning of the holder blocks of said cutters and said supplementary holder blocks respectively and a magnet embedded in each of said locating grooves for securing the associating holder blocks by magnetic attraction; the PCB cutter module further comprises a plurality of position limit means respectively provided between said locating grooves and said holder blocks of said cutters and said supplementary holder blocks to prohibit displacement of said holder blocks of said cutters and said supplementary holder blocks relative to said locating grooves, each said position limit means comprising a female engagement member located on one side of the peripheral wall of one said locating groove, and a male engagement member protruded from one side of the associating holder block or supplementary holder block for engagement with said female engagement member.

5. The PCB cutter module as claimed in claim 2, wherein said base further comprises a mold plate detachably covered on said worktable and a plurality of fastening members adapted for fastening said mold plate to said worktable, said mold plate having a plurality of locating grooves for the positioning of the holder blocks of said cutters and said supplementary holder blocks respectively and a magnet embedded in each of said locating grooves for securing the associating holder blocks by magnetic attraction; the PCB cutter module further comprises a plurality of position limit means respectively provided between said locating grooves of said mold plate and said holder blocks of said cutters and said supplementary holder blocks to prohibit displacement of said holder blocks of said cutters and said supplementary holder blocks relative to said locating grooves, each said position limit means comprising a male engagement member protruded from one side of the peripheral wall of one said locating groove of said mold plate and a female engagement member located on one side of the associating holder block or supplementary holder block for engagement with said male engagement member.

6. The PCB cutter module as claimed in claim 2, wherein said base further comprises a mold plate detachably covered on said worktable and a plurality of fastening members adapted for fastening said mold plate to said worktable, said mold plate having a plurality of locating grooves for the positioning of the holder blocks of said cutters and said supplementary holder blocks respectively and a magnet embedded in each of said locating grooves for securing the associating holder blocks by magnetic attraction; the PCB cutter module further comprises a plurality of position limit means respectively provided between said locating grooves of said mold plate and said holder blocks of said cutters and said supplementary holder blocks to prohibit displacement of said holder blocks of said cutters and said supplementary holder blocks relative to said locating grooves, each said position limit means comprising a female engagement member located on one side of the peripheral wall of one said locating groove of said mold plate and a male engagement member protruded from one side of the associating holder block or supplementary holder block for engagement with said female engagement member.

7. The PCB cutter module as claimed in claim 1, wherein said base has a rectangular profile, a plurality of positioning means located on the border thereof for positioning in a platform of a processing machine.

8. A PCB cutter module, comprising:
a base, said base having a magnetically attractive worktable provided at a top side thereof, said magnetically attractive worktable having a plurality of locating grooves arranged at predetermined locations and extending in predetermined directions; and
a plurality of cutters detachably mounted in said locating grooves of said magnetically attractive worktable for cutting a workpiece, each said cutter comprising a holder block secured to said magnetically attractive worktable by magnetic attraction and a cutter element fastened to said holder block for cutting a workpiece.

9. The PCB cutter module as claimed in claim 8, wherein said base has a rectangular profile, a plurality of positioning means located on the border thereof for positioning in a platform of a processing machine.

10. The PCB cutter module as claimed in claim 8, further comprising a plurality of supplementary holder blocks secured to said magnetically attractive worktable by magnetic attraction, each said supplementary holder block having a locating hole located on the topmost edge thereof, and an alignment rod mounted in the locating hole of each of said supplementary holder blocks.

11. The PCB cutter module as claimed in claim 8, further comprising a plurality of position limit means respectively provided between said locating grooves and said holder blocks of said cutters and said supplementary holder blocks to prohibit displacement of said holder blocks of said cutters and said supplementary holder blocks relative to said locating grooves, each said position limit means comprising a male engagement member protruded from one side of the peripheral wall of one said locating groove and a female engagement member located on one side of the associating holder block or supplementary holder block for engagement with said male engagement member.

12. The PCB cutter module as claimed in claim 8, further comprising a plurality of position limit means respectively provided between said locating grooves and said holder blocks of said cutters and said supplementary holder blocks to prohibit displacement of said holder blocks of said cutters and said supplementary holder blocks relative to said locating grooves, each said position limit means comprising a female engagement member located on one side of the peripheral wall of one said locating groove and a male engagement member protruded from one side of the associating holder block or supplementary holder block for engagement with said female engagement member.
